(19) United States
(12) Patent Application Publication
(10) Pub. No.: US 2014/0308941 A1
(43) Pub. Date: Oct. 16, 2014

(54) METHOD AND APPARATUS FOR DYNAMICALLY CONTROLLING ACCESS TO FEMTO CELL ACCESS POINT

(71) Applicant: ELECTRONICS AND TELECOMMUNICATIONS RESEARCH INSTITUTE, Daejeon-city (KR)

(72) Inventors: Nak-Woon SUNG, Daejeon (KR); Sook-Jin LEE, Daejeon (KR)

(73) Assignee: ELECTRONICS AND TELECOMMUNICATIONS RESEARCH INSTITUTE, Daejeon-city (KR)

(21) Appl. No.: 14/248,900

(22) Filed: Apr. 9, 2014

(30) Foreign Application Priority Data
Apr. 16, 2013 (KR) 10-2013-0041574

(51) Int. Cl. H04W 48/02

(52) U.S. Cl. CPC H04W 48/02
USPC 455/418

(57) ABSTRACT

An apparatus and method are disclosed for dynamically controlling access to a Femto Cell Access Point (FAP). The apparatus includes a policy configuration unit, a mode setting unit, a use information acquisition unit, and an available information extraction unit. The policy configuration unit configures a policy for switching between a first mode in which a Mobile Station (MS) of a non-subscriber of the FAP is prevented from being connected to the FAP and a second mode in which the MS of the non-subscriber of the FAP is permitted to be connected to the FAP. The mode setting unit sets an access mode of the FAP to the first or second mode according to the policy. The use information acquisition unit obtains use information. The available information extraction unit extracts available information.

### CROSS REFERENCE TO RELATED APPLICATION

This application claims the benefit of Korean Patent Application No. 10-2013-0041574, filed on Apr. 16, 2013, which is hereby incorporated by reference in its entirety into this application.

### BACKGROUND OF THE INVENTION

1. Technical Field

The present invention relates generally to a method and apparatus for dynamically controlling access to a femto cell access point (FAP) and, more particularly, to a method and apparatus for dynamically controlling access to an FAP, which are capable of configuring a policy that switches the access mode of an FAP in a heterogeneous network, flexibly switching the access mode of the FAP according to the policy, and offloading the data of a macro base station (MBS) by encouraging the use of the FAP.

2. Description of the Related Art

An FAP is a small-sized base station (BS) that performs indoor transmission with low power. Due to a short distance between an FAP and a BS, coverage and a capacity are improved and interference is reduced, with the result that the Quality of Service (QoS) of a user is improved. From the point of view of a service provider, there is an advantage in that more resources can be provided to users via an FAP than an MBS at lower investment cost. The reason for this is that an FAP bypasses mobile user data over a subscriber network. Accordingly, FAP technology has been attracting attention as price-competitive indoor coverage technology. A subscriber purchases an FAP, and installs the FAP at a specific location. The subscriber can limit access to the FAP and provide access to only a permitted Mobile Terminal (MS).

In a common FAP operation scenario, access to an FAP can be limited using the following three modes. An FAP that operates in Closed Subscriber Group (CSG) mode permits only the subscribers of a CSG access thereto. In contrast, an FAP that operates in Open Subscriber Group (OSG) mode permits all non-subscribers access thereto. Like in OSG mode, an FAP that operates in CSG-open mode permits non-subscribers access thereto. However, an FAP assigns specific resources to CSG subscribers first and then assigns only the remaining resources to non-subscribers.

In conventional technology, an FAP selects one from among the three types of modes, and operates in the selected mode. In conventional technology, the three types of access modes provide advantages and disadvantages. The CSG-closed mode is advantageous in that a subscriber of an FAP can control access to a base station according to preference. Accordingly, the subscriber can install an FAP at a specific location according to preference, and can use mobile broadband service. However, an FAP operating in such CSG-closed mode generates interference to neighboring MBS users and neighboring FAPs. The interference problem related to MBS users is an important issue because a large number of small-sized FAPs can be installed and operated. If the FAP operates in OSG mode, such an interference problem can be eliminated. The reason for this is that if an MBS user uses the FAP, the FAP no longer serves as an interference source. If the FAP operates in OSG mode, however, there is a problem in that a subscriber of the FAP must pay fees for a subscriber network (assuming that the FAP is connected to the subscriber network) in order for other users to use the FAP. For this reason, there has been proposed a CSG-open mode, that is, a hybrid mode that is a compromise between the two types of access modes. In such hybrid mode, there is a problem in that the quantities of the resources of an FAP and the resources of a subscriber network (i.e., an IP backhaul network) that should be assigned to subscribers and non-subscribers should be determined.

In the conventional technologies, such as the technology disclosed in Korean Patent Application Publication No. 2010-0098339, if the number of common FAPs is large, the common FAPs are not used by CSGs around the clock in many cases. However, a common FAP has been configured to operate in one of the three types of access modes. Furthermore, a method for dynamic switching between access modes has not been defined. In the conventional technologies, an FAP needs to operate in OSG mode in order to control interference and improve indoor coverage. If many FAPs operate in OSG mode, the overall system performance of a network can be improved. However, the conventional technologies are problematic in that no benefits are provided to the owner of an FAP when the FAP operates in OSG mode.

### SUMMARY OF THE INVENTION

Accordingly, the present invention has been made keeping in mind the above problems occurring in the prior art, and an object of the present invention is to enable an FAP to dynamically switch its access mode according to circumstances and operate in the switched mode.

Another object of the present invention is to enable an FAP to operate in OSG mode during the time for which the terminal of a subscriber of the FAP is not used so that the occurrence of interference is minimized and the overall performance of a system is improved.

Yet another object of the present invention is to motive an FAP to operate in OSG mode by providing benefits to the subscribers of the FAP when the FAP operates in the OSG mode.

In accordance with an aspect of the present invention, there is provided a method for dynamically controlling access to an FAP, the method including configuring a policy for switching between a first mode in which the MS of a non-subscriber of an FAP is prevented from being connected to the FAP and a second mode in which the MS of the non-subscriber of the FAP is permitted to be connected to the FAP; setting an access mode of the FAP to the first or second mode according to the policy; obtaining use information, that is, the amount of data that has been used by the MS of the non-subscriber when the MS is connected to the FAP; and extracting available information, that is, the amount of data that can be used by an MS of a subscriber of the FAP in connection with a base station to which the subscriber of the FAP has not subscribed based on the use information.

The method may further include, after extracting the available information, sending the use information and the available information to a data use history management server for storing and managing a history of data used.

The first mode may be a Close Subscriber Group (CSG) mode in which only the MS of the subscriber of the FAP is permitted to be connected to the FAP.

The second mode may be an Open Subscriber Group (OSG) mode in which the MS of the subscriber of the FAP and the MS of the non-subscriber of the FAP are permitted to be connected to the FAP.

Setting the access mode of the FAP may be automatically performed in real time.

The policy may be a user designation mode in which the FAP is set to a CSG mode when the MS of the subscriber of the FAP is connected to the FAP and the FAP is set to an OSG mode if the connections between all MSs of all subscribers of the FAP and the FAP have been terminated.

The policy may be a time designation mode in which the FAP is set to a CSG mode only for a designated time designated by the subscriber.

Configuring the policy may include selecting the policy in response to input from the subscriber of the FAP.

Setting the access mode of the FAP may include switching the access mode to a Low Duty Mode (LDM) including an available interval and an unavailable interval if the access mode is set to the first mode and the MS of the non-subscriber of the FAP has not been connected to the FAP for a specific time.

The method may further include, after switching to the LDM, switching to the second mode when the MS of the non-subscriber is connected to the FAP.

The method may further include, after switching to the second mode, switching to the first mode if the MS of the subscriber of the FAP is connected to the FAP.

In accordance with another aspect of the present invention, there is provided an apparatus for dynamically controlling access to an FAP, the apparatus including a policy configuration unit adapted to configure a policy for switching between a first mode in which the MS of a non-subscriber of the FAP is prevented from being connected to the FAP and a second mode in which the MS of the non-subscriber of the FAP is permitted to be connected to the FAP; a mode setting unit adapted to set an access mode of the FAP to the first or second mode according to the policy; a use information acquisition unit adapted to obtain use information, that is, the amount of data that has been used by the MS of the non-subscriber when the MS is connected to the FAP; and an available information extraction unit adapted to extract available information, that is, the amount of data that can be used by a subscriber of the FAP in connection with a base station to which the subscriber of the FAP has not subscribed based on the use information.

The apparatus may further include a transmission unit adapted to send the use information and the available information to a data use history management server for storing and managing a history of data used.

The first mode may be a Close Subscriber Group (CSG) mode in which only the MS of the subscriber of the FAP is permitted to be connected to the FAP.

The second mode may be an Open Subscriber Group (OSG) mode in which the MS of the subscriber of the FAP and the MS of the non-subscriber of the FAP are permitted to be connected to the FAP.

The policy may be a user designation mode in which the FAP is set to a CSG mode when the MS of the subscriber of the FAP is connected to the FAP and the FAP is set to an OSG mode if the connections between MSs of all subscribers of the FAP and the FAP have been terminated.

The policy may be a time designation mode in which the FAP is set to a CSG mode only for a designated time designated by the subscriber.

The access mode may be switched to a Low Duty Mode (LDM) including an available interval and an unavailable interval if the access mode is set to the first mode and the MS of the non-subscriber of the FAP has not been connected to the FAP for a specific time.

The LDM may be switched to the second mode if the MS of the non-subscriber of the FAP is connected to the FAP.

The LDM may be switched to the first mode if the MS of the subscriber of the FAP is connected to the FAP.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a network configuration related to Femto cell Access Points (FAPs) according to the present invention;

FIG. 2 is a block diagram of an apparatus for dynamically controlling access to an FAP according to the present invention;

FIG. 3 is a flowchart illustrating a method for dynamically controlling access to an FAP according to an embodiment of the present invention;

FIG. 4 is a flowchart illustrating the switching of the access mode of an FAP in time designation mode;

FIG. 5 is a flowchart illustrating the switching of the access mode of an FAP in user designation mode; and

FIG. 6 shows an embodiment of the switching of the access mode of an FAP in user designation mode.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

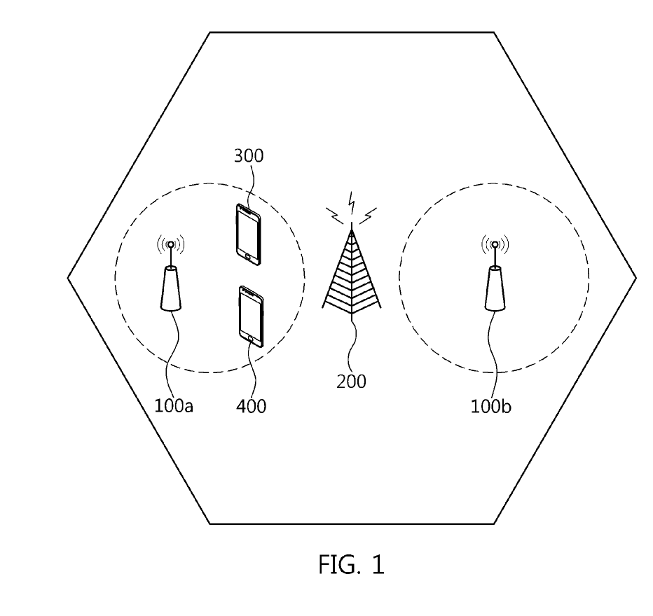

A network configuration related to FAPs according to an embodiment of the present invention the FAP will be described below. FIG. 1 is a diagram illustrating a network configuration related to FAPs according to an embodiment of the present invention.

Referring to FIG. 1, the network configuration includes Mobile Stations (MSs) 300 and 400, an MBS 200, and Femto cell Access Points (FAPs) 100a and 100b.

An example of the FAP network configuration of a mobile communication system including a common MBS and FAPs is illustrated. In general, 3G or 4G service using a mobile communication system is poor in indoor service because it operates in a high band. There is a need for price-competitive indoor coverage technology, an example of which is femto cell technology. An FAP has a coverage region in the range of about 20 to 50 m, and the FAP is installed by a subscriber as desired, rather than by a service provider. Accordingly, as illustrated in FIG. 1, a plurality of the FAPs 100a and 100b may be installed in one MBS 200. In most cases, interference is generated between the MBS and the FAPs or between the FAPs because the MBS and the FAPs use the same frequency band for the efficiency of frequency use.

As described above, in a common FAP operation scenario, an FAP may operate in CSG-closed mode, CSG-open mode, and OSG mode. However, it may be more efficient if an FAP operates in different access modes depending on the access situation of an MS. For example, assuming that a specific subscriber works for a specific time of the day and an FAP operates only in CSG-closed mode, there are problems in that the efficiency of use of the FAP is low and the FAP serves as only an interference source. Accordingly, if the FAP operates in CSG-closed mode only when a CSG subscriber accesses the FAP or only for a specific time and operates in OSG mode for the remaining time, the problems can be solved. Furthermore, if a subscriber is allowed to use another OSG FAP or the MBS by the total amount of data service that has been contributed by using its FAP in OSG mode, more subscribers can be motivated to use their FAPs in OSG mode. The present invention provides such a method, which will be described in detail below.

Furthermore, the MSs 300 and 400 manage CSG white lists. Each of the MSs 300 and 400 may determine whether a corresponding CSG FAP is a base station that the MS has been permitted to access using the list. Furthermore, the MS may connect to the MBS and the FAPs in the three types of modes. In FAP-only mode, an MS connects to only an FAP. In such mode, the MS is not connected to an MBS even when it can be connected to the MBS. In MBS-only mode, an MS is connected to only an MBS. In such mode, the MS is not connected to an FAP even when it can be connected to the FAP. In dual mode, an MS is connected to only one of an FAP and an MBS depending on the scheme of a base station. An MBS provides common cellular service. In addition, the MBS transfers information about the total amount of mobile data used in the current base station of each mobile MS to a data use history management server 500. As described above, an MS operates in the three types of modes. In the user designation mode of the present invention, an FAP operates in CSG mode only when an MS is set such that it operates in FAP-only mode or dual mode and is connected to the FAP. Accordingly, the FAP operates in OSG mode when an MS is set such that it operates in MBS-only mode or dual mode and is connected to an MBS. In the time designation mode of the present invention, a CSG subscriber is treated like a non-subscriber in the remaining time other than the time set for CSG-Closed mode. However, only in FAP-only mode or dual mode, the CSG subscriber can be connected to an FAP. Like in the conventional technologies, the distinction between an MBS and an FAP and the distinction among the modes for controlling access to an FAP are performed using preamble and base station identifier (BSID) information that is broadcasted by a base station.

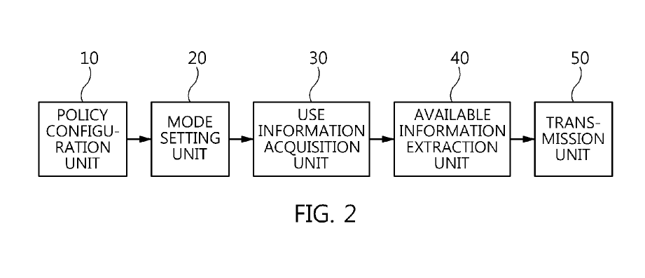

The construction and operation of an apparatus for dynamically controlling access to an FAP according to an embodiment of the present invention will be described below. FIG. 2 is a block diagram of the apparatus for dynamically controlling access to an FAP according to an embodiment of the present invention.

Referring to FIGS. 1 and 2, the apparatus for dynamically controlling access to an FAP according to this embodiment of the present invention includes a policy configuration unit 10, a mode setting unit 20, a use information acquisition unit 30, an available information extraction unit 40, and a transmission unit 50.

The policy configuration unit 10 configures a policy related to switching between a first mode in which the MS 400, which is the terminal of a non-subscriber of the FAP 100a, is prevented from being connected to the FAP 100a and a second mode in which the MS 400, which is the terminal of a non-subscriber of the FAP 100a, is permitted to be connected to the FAP 100a. That is, the policy configuration unit 10 presents a criterion for switching between the first mode and the second mode. The process of selecting and configuring the policy may be performed in response to input from a subscriber of the FAP 100a. The policy may include a user designation mode and a time designation mode. In the user designation mode, the FAP 100a is set to a CSG mode if the MS, which is the terminal of a subscriber of the FAP 100a, is connected to the FAP 100a, and the FAP 100a is set to an OSG mode if the connections between the MSs of all subscribers and the FAP 100a have been terminated. Furthermore, in the time designation mode, the FAP 100a is set to a CSG mode only for a designated time. When the FAP 100a is set to the time designation mode, even the terminal of a non-subscriber of the FAP 100a may be connected to the FAP 100a because the FAP 100a is set to the OSG mode in the remaining time that has not been designed by the subscriber of the MS.

The mode setting unit 20 sets the access mode of the FAP 100a according to the policy. The access mode may include the first mode and the second mode. The first mode may be a CSG mode in which only the MS 300, which is the terminal of a subscriber of the FAP 100a, is permitted to be connected to the FAP 100a. When the MS 300 is set to a CSG mode, the MS 400, which is the terminal of a non-subscriber of the FAP 100a, cannot be connected to the FAP 100a. Furthermore, the second mode may be an OSG mode in which the MS 300, which is the terminal of a subscriber of the FAP 100a, and the MS 400, which is the terminal of a non-subscriber of the FAP 100a, are permitted to be connected to the FAP 100a. Accordingly, if the FAP 100a is set to an OSG mode, even the terminal of a non-subscriber of the FAP 100a may be connected to the FAP 100a.

The use information acquisition unit 30 obtains use information, that is, the amount of data that has been used by the MS 400, which is the terminal of a non-subscriber of the FAP 100a, after the MS 400 was connected to the FAP 100a.

The available information extraction unit 40 extracts available information, that is, the amount of data by which a subscriber of the FAP 100a may use another FAP 100b to which the subscriber of the FAP 100a has not subscribed based on the use information according to the price policy of a service provider using the use information stored in the data use history management server 500. For example, a subscriber may use the FAP 100b to which the subscriber has not subscribed by the total amount of data that the subscriber has served to the MS 400, which is the terminal of a non-subscriber, using the FAP 100a installed by the subscriber. For another example, a subscriber may use the total amount of data equal to or smaller than that amount of data that the subscriber has served to the MS 400, which is the terminal of a non-subscriber, using its FAP 100a through the MBS 200. It may be reasonable to be served a small amount of data because the resources of the MBS 200 are commonly more expensive. Accordingly, in the present invention, an MS is motivated to make its FAP operate in OSG mode even when the MS is located in its CSG FAP region. Furthermore, the use information and the available information are transmitted to the data use history management server 500 for storing and managing the history of data used via the transmission unit 50. The data use history management server 500 manages and stores information about the amount of data that has been used by each of the MSs in the MBS 200 and the FAPs 100a and 100b.

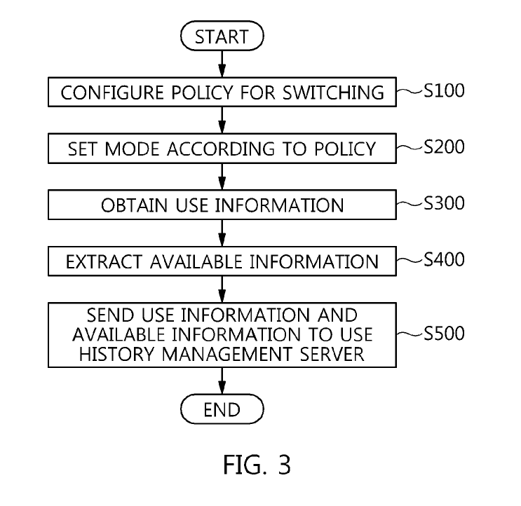

The method for dynamically controlling access to an FAP according to the present invention will be described below. FIG. 3 is a flowchart illustrating a method for dynamically controlling access to an FAP according to the present invention.

Referring to FIGS. 1 and 3, the method for dynamically controlling access to an FAP according to the present invention includes configuring a policy for switching between a first mode in which an MS, which is the terminal of a non-subscriber of an FAP, is prevented from being connected to the FAP and a second mode in which the MS of the non-subscriber is permitted to be connected to the FAP at step S100; setting the access mode of the FAP to the first or second mode according to the policy at step S200, obtaining use information, that is, the amount of data used by the MS of the non-subscriber connected to the FAP at step S300, and extracting available information, that is, the amount of data that may be used by the terminal of a subscriber of the FAP in connection with a base station to which the subscriber of the FAP has not subscribed based on the use information, at step S400.

At step S100, a policy for switching between the first mode in which the MS 400, which is the terminal of a non-subscriber of the FAP 100a, is prevented from being connected to the FAP 100a and the second mode in which the MS 400, which is the terminal of the non-subscriber of the FAP 100a, is permitted to be connected to the FAP 100a is configured. That is, a criterion for switching between the first mode and the second mode is presented. A process of selecting and configuring the policy may be performed in response to input from a subscriber of the FAP 100a. The policy includes a user designation mode and a time designation mode. In the user designation mode, when the MS 300, which is the terminal of a subscriber of the FAP 100a, is connected to the FAP 100a, the FAP 100a is set to a CSG mode. If the connections between the MSs 300 of all subscribers and the FAP 100a have been terminated, the FAP 100a is set to an OSG mode. Furthermore, in the time designation mode, the FAP 100a is set to a CSG mode only for a designated time. If the FAP 100a is set to the time designation mode, even the terminal of a non-subscriber of the FAP 100a can be connected to the FAP 100a because the FAP 100a is set to an OSG mode in the remaining time that has not been designed by the subscriber of the MS. Furthermore, at step S100, the policy may be selected in response to input from a subscriber of the FAP 100a.

At step S200, the access mode of the FAP 100a is set according to the policy. The access mode includes a first mode and a second mode. The first mode may be a CSG mode in which only the MS 300, which is the terminal of a subscriber of the FAP 100a, is permitted to be connected to the FAP 100a. When the MS 300 is set to a CSG mode, the MS 400, which is the terminal of a non-subscriber of the FAP 100a, cannot be connected to the FAP 100a. Furthermore, the second mode may be an OSG mode in which the MS 300, which is the terminal of a subscriber of the FAP 100a, and the MS 400, which is the terminal of a non-subscriber of the FAP 100a, is permitted to be connected to the FAP 100a. Accordingly, when the FAP 100a is set to an OSG mode, even the terminal of a non-subscriber of the FAP 100a can be connected to the FAP 100a. Step S200 may be automatically performed according to the policy in real time.

At step S300, use information, that is, the amount of data used by the MS of a non-subscriber of the FAP when the MS is connected to the FAP, is obtained.

At step S400, available information, that is, the amount of data by which a subscriber of the FAP may use another FAP to which the subscriber of the FAP has not subscribed based on the use information according to the price policy of a service provider using the use information stored in the data use history management server 500, is extracted. For example, a subscriber may use the FAP to which the subscriber of has not subscribed by the total amount of data that the subscriber has served the MS, which is the terminal of a non-subscriber, using the FAP installed by the subscriber. For another example, a subscriber may use an amount of data equal to or smaller than the amount of data that the subscriber has served the MS, which is the terminal of a non-subscriber, using its FAP through the MBS. It will be reasonable to serve a small amount of data because the resources of the MBS are commonly more expensive. For example, if a non-subscriber that has not subscribed to an FAP has used 100 Mbytes, a subscriber of the FAP can use 100 Mbytes in another FAP to which the subscriber of the FAP has not subscribed, and may use 50 Mbytes smaller than the amount of data, that is, 100 Mbytes, in the MBS according to the price policy of a service provider. Accordingly, in the present invention, an MS is motivated to make its FAP operate in the OSG mode even when the MS is located in its CSG FAP region.

At step S500, the use information and the available information are transmitted to the data use history management server 500 for storing and managing the history of data used. The data use history management server 500 manages and stores use information, that is, the amount of data used by each of the MSs in the MBS 200 and the FAP 100a, and available information.

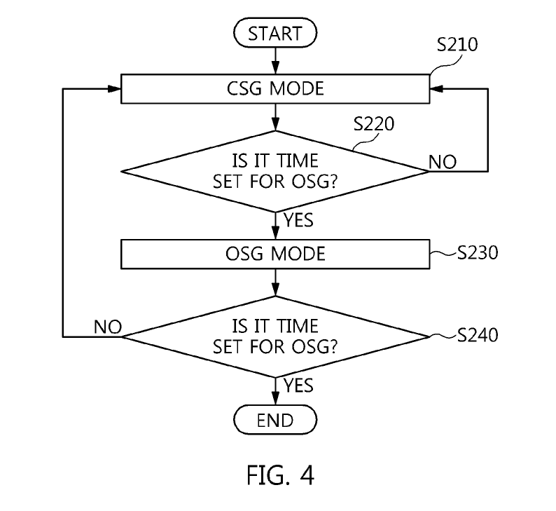

The switching of the access mode of the FAP in the time designation mode will be described below. FIG. 4 is a flowchart illustrating the switching of the access mode of the FAP in the time designation mode.

Referring to FIG. 4, the access mode is maintained in CSG mode at step S210. Whether the time on which a user has set access mode in OSG mode has been reached is determined at step S220. If the time that the user has designated to switch the access mode to an OSG mode has been reached, the access mode is switched to the OSG mode at step S230. If the time that the user has designated to switch the access mode to the OSG mode has not been reached, the access mode is maintained in the CSG mode at step S210.

If there has not been a connection from the MS of a non-subscriber for a specific time even when the access mode has been set to the first mode, the access mode is switched to a Low Duty Mode (LDM) including an Available Interval (AI) and an UnAvailable Interval (UAI). The LDM is a mode that is defined in IEEE 802.16m. If the MS of a non-subscriber of an FAP has not been connected to the FAP for a specific time in the first mode, the FAP enters the LDM. The FAP permits the scanning of another MS during the AI.

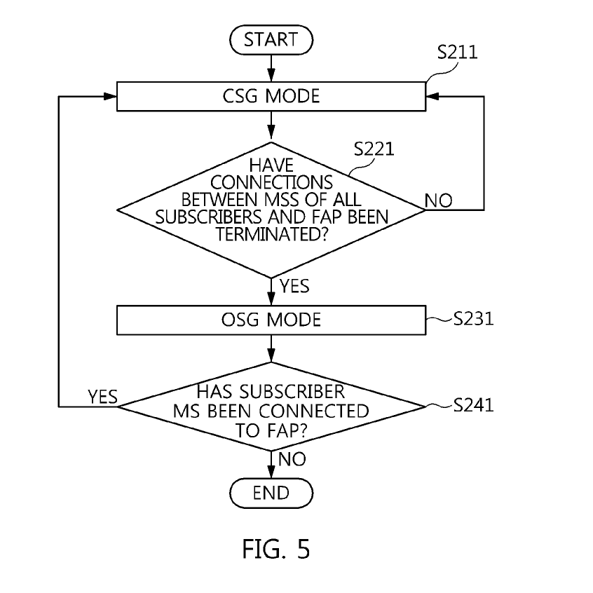

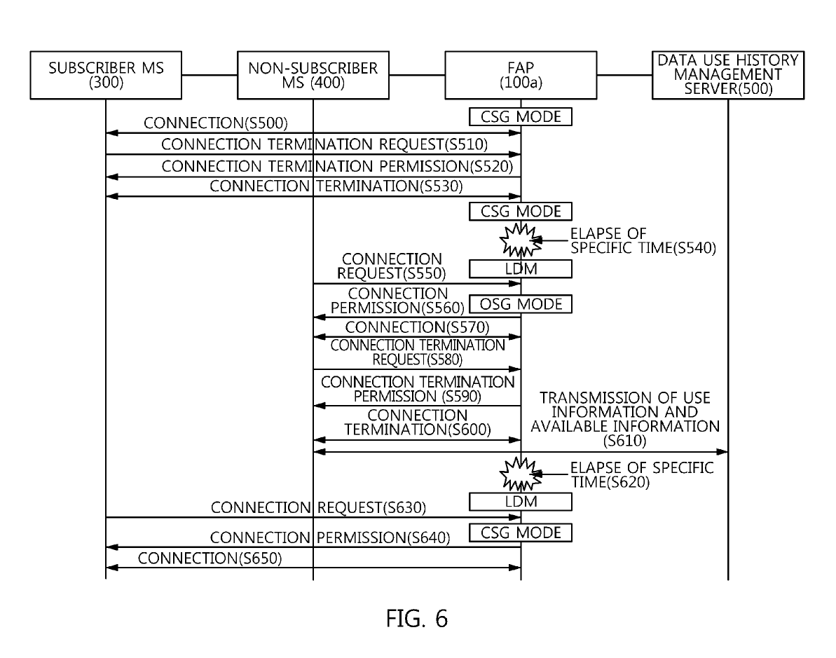

The switching of the access mode of the FAP in user designation mode will be described below. FIG. 5 is a flowchart illustrating the switching of the access mode of the FAP in user designation mode, and FIG. 6 illustrates an embodiment of the switching of the access mode of the FAP in user designation mode.

The case where the policy for switching between a first mode in which the MS 400, which is the terminal of a non-subscriber of the FAP 100a, is prevented from being connected to the FAP 100a and a second mode in which the MS that is the non-subscriber is permitted to be connected to the FAP is a user designation mode will be described with reference to FIGS. 5 and 6. In the case of the user designation mode, only when the MS 300, which is the terminal of a subscriber of the FAP 100a, is connected to the FAP 100a, the FAP 100a operates in CSG mode at step S211. As can be seen from step S241 of FIG. 5, if any one MS, which is terminal of a subscriber of the FAP 100a, is connected to the FAP 100a, the FAP 100a operates in CSG mode. If the connections between all MSs, which are the terminals of all subscribers, and the FAP 100a have been terminated, the FAP 100a is switched to an OSG mode at step S221, and the service for a non-subscriber of the FAP 100a starts. If any MS 300, which is the terminal of a subscriber of the FAP 100a, is connected to the FAP 100a, the FAP 100a is automatically switched to a CSG mode in real time at step S211. Accordingly, the service for the MS 400, which is the terminal of a non-subscriber of the FAP 100a, is terminated, and the service for the subscriber is performed.

At step S200, if the MS 400 of a non-subscriber of the FAP 100a has not been connected to the FAP 100a for a specific time even when the access mode is set to a first mode, the access mode is switched to an LDM including the AI and the UAI. The LDM is a mode that is defined in IEEE 802.16m. If the MS 400 of the non-subscriber of the FAP 100a has not been connected to the FAP 100a for a specific time in the first mode, the FAP enters the LDM. The FAP 100a permits the scanning of another MS during the AI.

Furthermore, after switching to the LDM, when the MS 400, which is the terminal of a non-subscriber of the FAP 100a, is connected to the FAP 100a, the FAP 100a is switched to the second mode. Furthermore, after switching to the second mode, when the MS 300, which is the terminal of a subscriber of the FAP 100a, is connected to the FAP 100a, the FAP 100a is switched to the first mode.

Referring to FIG. 6, since a CSG mode is set as the initial mode of the user designation mode, the FAP 100a and the MS 300, which is the terminal of a subscriber of the FAP 100a, are connected to each other at step S500. In this state, when the MS 300, which is the terminal of a subscriber of the FAP 100a, requests the termination of the connection from the FAP 100a at step S510, the FAP 100a permits the termination of the connection at step S520, with the result that the connection between the MS 300 and the FAP 100a is terminated at step S530.

When the connection between the MS 300 and the FAP 100a is terminated, any MS 300, which is the terminal of a subscriber, is not connected to the FAP 100a. Accordingly, the FAP 100a is switched to the OSG mode in real time according to the policy defined in the user designation mode. In the OSG mode, even the terminal of a non-subscriber of the FAP 100a may be connected to the FAP 100a. If any non-subscriber is not connected to the FAP 100a even when a specific time has elapsed at step S540, the OSG mode is switched to the LDM.

In the state in which LDM has been set, when the MS 400, which is the terminal of a non-subscriber of the FAP 100a, requests a connection with the FAP 100 at step S550, the LDM is switched to an OSG mode, and the connection is permitted at step S560, with the result that the MS 400, which is the terminal of a non-subscriber, and the FAP 100a are connected to each other at step S570. In this state, when the MS 400, which is the terminal of a non-subscriber, requests the termination of the connection from the FAP 100a at step S580 and the FAP 100a permits the termination of the connection with the MS 400, which is the terminal of a non-subscriber, at step S590, the connection between the MS 400, which is the terminal of a non-subscriber, and the FAP 100a is terminated at step S600.

In this case, the FAP 100a obtains use information, that is, the amount of data that has been used by the MS, which is the terminal of a non-subscriber in the FAP 100a. Furthermore, the FAP 100a extracts available information, that is, the amount of data that may be used by the terminal of a subscriber of the FAP 100a in a base station to which the subscriber of the FAP 100a has not subscribed based on the use information.

Thereafter, the use information and the available information are transmitted to the data use history management server 500 at step S610. Furthermore, since the MS 400, which is the terminal of a non-subscriber of the FAP 100a, is not connected to the FAP 100a, the FAP 100a is switched to the LDM if the MS 400 is not connected to the FAP 100a even after a specific time has elapsed at step S620. Here, when the MS 300, which is the terminal of a subscriber of the FAP 100a, requests a connection from the FAP 100a at step S630, the FAP 100a is switched to the CSG mode, the connection is permitted at step S640, and thus the MS 300 and the FAP 100a are connected to each other at step S650.

As described above, the present invention is advantageous in that an FAP can dynamically switch its access mode according to circumstances.

Furthermore, the present invention is advantageous in that it can minimize the occurrence of interference and improve the overall performance of a system because an FAP operates in OSG mode during the time for which the FAP is not used by the terminal of a subscriber of the FAP.

Furthermore, the present invention is advantageous in that an FAP is motivated to operate in OSG mode by providing benefits to a subscriber of the FAP when the FAP operates in the OSG mode.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for dynamically controlling access to a Femto Cell Access Point (FAP), the method comprising:
configuring a policy for switching between a first mode in which a Mobile Station (MS) of a non-subscriber of an FAP is prevented from being connected to the FAP and a second mode in which the MS of the non-subscriber of the FAP is permitted to be connected to the FAP;
setting an access mode of the FAP to the first or second mode according to the policy;
obtaining use information, that is, an amount of data that has been used by the MS of the non-subscriber when the MS is connected to the FAP; and
extracting available information, that is, an amount of data that can be used by an MS of a subscriber of the FAP in connection with a base station to which the subscriber of the FAP has not subscribed based on the use information.

2. The method of claim 1, further comprising, after extracting the available information, sending the use information and the available information to a data use history management server for storing and managing a history of data used.

3. The method of claim 1, wherein the first mode is a Close Subscriber Group (CSG) mode in which only the MS of the subscriber of the FAP is permitted to be connected to the FAP.

4. The method of claim 1, wherein the second mode is an Open Subscriber Group (OSG) mode in which the MS of the subscriber of the FAP and the MS of the non-subscriber of the FAP are permitted to be connected to the FAP.

5. The method of claim 1, wherein setting the access mode of the FAP is automatically performed in real time.

6. The method of claim 1, wherein the policy is a user designation mode in which the FAP is set to a CSG mode when the MS of the subscriber of the FAP is connected to the FAP and the FAP is set to an OSG mode if connections between all MSs of all subscribers of the FAP and the FAP have been terminated.

7. The method of claim 1, wherein the policy is a time designation mode in which the FAP is set to a CSG mode only for a designated time designated by the subscriber.

8. The method of claim 1, wherein configuring the policy comprises selecting the policy in response to input from the subscriber of the FAP.

9. The method of claim 1, wherein setting the access mode of the FAP comprises switching the access mode to a Low Duty Mode (LDM) including an available interval and an unavailable interval if the access mode is set to the first mode and the MS of the non-subscriber of the FAP has not been connected to the FAP for a specific time.

10. The method of claim 9, further comprising, after switching to the LDM, switching to the second mode when the MS of the non-subscriber is connected to the FAP.

11. The method of claim 10, further comprising, after switching to the second mode, switching to the first mode if the MS of the subscriber of the FAP is connected to the FAP.

12. An apparatus for dynamically controlling access to an FAP, the apparatus comprising:
a policy configuration unit adapted to configure a policy for switching between a first mode in which an MS of a non-subscriber of the FAP is prevented from being connected to the FAP and a second mode in which the MS of the non-subscriber of the FAP is permitted to be connected to the FAP;
a mode setting unit adapted to set an access mode of the FAP to the first or second mode according to the policy;
a use information acquisition unit adapted to obtain use information, that is, an amount of data that has been used by the MS of the non-subscriber when the MS is connected to the FAP; and
an available information extraction unit adapted to extract available information, that is, an amount of data that can be used by a subscriber of the FAP in connection with a base station to which the subscriber of the FAP has not subscribed based on the use information.

13. The apparatus of claim 12, further comprising a transmission unit adapted to send the use information and the available information to a data use history management server for storing and managing a history of data used.

14. The apparatus of claim 12, wherein the first mode is a Close Subscriber Group (CSG) mode in which only the MS of the subscriber of the FAP is permitted to be connected to the FAP.

15. The apparatus of claim 12, wherein the second mode is an Open Subscriber Group (OSG) mode in which the MS of the subscriber of the FAP and the MS of the non-subscriber of the FAP are permitted to be connected to the FAP.

16. The apparatus of claim 12, wherein the policy is a user designation mode in which the FAP is set to a CSG mode when the MS of the subscriber of the FAP is connected to the FAP and the FAP is set to an OSG mode if connections between MSs of all subscribers of the FAP and the FAP have been terminated.

17. The apparatus of claim 12, wherein the policy is a time designation mode in which the FAP is set to a CSG mode only for a designated time designated by the subscriber.

18. The apparatus of claim 12, wherein the access mode is switched to a Low Duty Mode (LDM) including an available interval and an unavailable interval if the access mode is set to the first mode and the MS of the non-subscriber of the FAP has not been connected to the FAP for a specific time.

19. The apparatus of claim 18, wherein the LDM is switched to the second mode if the MS of the non-subscriber of the FAP is connected to the FAP.

20. The apparatus of claim 19, wherein the LDM is switched to the first mode if the MS of the subscriber of the FAP is connected to the FAP.
